(19) United States
(12) Patent Application Publication
(10) Pub. No.: US 2011/0262663 A1
(43) Pub. Date: Oct. 27, 2011

(54) RETARDATION FILM, FABRICATION METHOD THEREOF, AND LIQUID CRYSTAL DISPLAY COMPRISING THE SAME

(75) Inventors: Jeong-Min Choi, Daejeon Metropolitan City (KR); Yoo-Seong Hong, Daejeon Metropolitan City (KR); Min-Hee Lee, Daejeon Metropolitan City (KR); Sang-Min Kwak, Daejeon Metropolitan City (KR); Jun-Geun Um, Gyeonggi-do (KR); Kyung-Sik Kim, Daejeon Metropolitan City (KR)

(73) Assignee: LG CHEM, LTD

(21) Appl. No.: 12/864,203

(22) PCT Filed: Jan. 22, 2009
(86) PCT No.: PCT/KR09/00332

§ 371 Date: Dec. 13, 2010

(30) Foreign Application Priority Data
Jan. 23, 2008 (KR) 10-2008-0007072

(51) Int. Cl. G02F 1/1335; B32B 27/18; C08L 35/06; C08L 51/04; C08L 51/00; G02B 1/08; B29D 7/01

(52) U.S. Cl. 428/1.33; 428/522; 264/210.1; 525/84; 525/85

(57) ABSTRACT

The present invention relates to a retardation film, a method for manufacturing the same, and a liquid crystal display device comprising the same. More particularly, the present invention relates to a retardation film which comprises 1) an acryl copolymer that comprises an acryl monomer and an aromatic vinyl monomer; and 2) a rubber component, and the retardation film according to the present invention has excellent optical transparency, haze, brittleness, mechanical strength, heat resistance and durability.

### TECHNICAL FIELD

The present invention relates to a retardation film, a method for manufacturing the same, and a liquid crystal display device including the same.

This application claims priority from Korea Patent Application No. 10-2008-0007072 filed on Jan. 23, 2008 in the KIPO, the disclosure of which is incorporated herein by reference in its entirety.

### BACKGROUND ART

Recently, display technologies using various methods such as a plasma display panel (PDP), a liquid crystal display (LCD) and the like that are used instead of a known brown tube in accordance with the development of optical technologies are suggested and sold. The higher properties of the polymer material for displays are required. For example, in the case of the liquid crystal display, according to the development toward the thin film, the lightness, and enlargement of the picture area, the wide viewing angle, the high contrast, the suppression of change in picture color tone according to the viewing angle and the uniformity of the picture display are particularly considered as important problems.

Therefore, various polymer films such as a polarizing film, a retardation film, a plastic substrate, a light guide plate and the like are used, and as the liquid crystal, various modes of liquid crystal displays such as twisted nematic (TN), super twisted nematic (STN), vertical alignment (VA), in-plane switching (IPS) liquid crystal cells are developed. Since these liquid crystal cells have all intrinsic liquid crystal alignment, the intrinsic optical anisotropic property is ensured, and in order to compensate the optical anisotropic property, a film in which a retardation function is provided by stretching various kinds of polymers has been suggested.

For example, as an example using a polycarbonate (PC) resin, there is Japanese Patent Application Laid-Open No. 9-304619. However, as described above, in the case of when the polycarbonate resin is stretched, it is possible to provide the sufficient retardation function as the retardation film, but the change in retardation is significant in respects to the degree of stretching and it is difficult to provide the film having the uniform and stable retardation function.

As a method for solving these problems, a method using a cyclic polyolefin polymer (COP) has been suggested (Japanese Patent Application Laid-Open Nos. 2001-350017 and 2004-51928). However, there is a problem in that the cyclic polyolefin resin has a reduced adhesion property in respects to other substrates such as films, and there is a problem in that since it has a small change ratio in retardation because of the extension, a sufficient retardation as a retardation film is not ensured.

Accordingly, in Japanese Patent No. 2886893, a copolymer resin of styrene and maleic anhydride that includes methyl methacrylate (MMA) as a main component and is extended is used as a retardation plate. As described in the patent document, if an acryl resin is used, a retardation plate that is transparent, has no haze, and has a predetermined retardation obtained through the extension may be manufactured.

However, in the case of when the retardation film is manufactured as suggested in the patent document, because of the characteristics of an acryl resin composition, the film is made brittle. Thus, there are problems in that unstability occurs in a roll while the film is processed and a difficulty in attachment to a polarizer occurs, which makes a processing process difficult, thus it is difficult for it to be used as the retardation film.

### DISCLOSURE OF INVENTION

### Technical Problem

It is an object of the present invention to provide a retardation film that has excellent optical characteristics such as the in-plane retardation, the thickness retardation, and excellent optical characteristics such as optical transparency, is capable of solving a disadvantage of a brittle acryl film, and has excellent processability, heat resistance, and durability.

### Technical Solution

Therefore, the present invention provides a retardation film which comprises 1) an acryl copolymer that comprises an acryl monomer and an aromatic vinyl monomer; and 2) a rubber component. An in-plane retardation value that is represented by the following Equation 1 is in the range of 50 to 300 nm, and a thickness retardation value that is represented by the following Equation 2 is in the range of 50 to 300 nm.

Rₑ=(Nₓ−N_{y})×d [Equation 1]

Rₜₕ=(N_{z}−N_{y})×d [Equation 2]

In Equations 1 and 2, Nₓ is an in-plane refractive index in an extending direction of the film, N_{y} is an in-plane refractive index in a direction that is vertical to the extending direction of the film, N_{z} is a refractive index of the thickness direction of the film, and d is the thickness of the film.

In addition, the present invention provides a method for manufacturing a retardation film, which comprises the steps of a) manufacturing an unstretched film by using an acryl copolymer that comprises an acryl monomer and an aromatic vinyl monomer and a rubber component; and b) stretching the unstretched film of step a). An in-plane retardation value that is represented by the following Equation 1 is in the range of 50 to 300 nm, and a thickness retardation value that is represented by the following Equation 2 is in the range of 50 to 300 nm.

In addition, the present invention provides a liquid crystal display device that comprises the retardation film.

### Advantageous Effects

A retardation film according to the present invention has excellent heat resistance and optical transparency, and low haze, is not broken, and has excellent mechanical strength and durability.

### BEST MODE FOR CARRYING OUT THE INVENTION

Hereinafter, the present invention will be described in detail below.

A retardation film according to the present invention comprises 1) an acryl copolymer that comprises an acryl monomer and an aromatic vinyl monomer; and 2) a rubber component.

In the retardation film according to the present invention, as the acryl monomer of 1) the acryl copolymer, methyl methacrylate, ethyl methacrylate, propyl methacrylate, n-butyl methacrylate, t-butyl methacrylate, cyclohexyl methacrylate, benzyl methacrylate, methoxyethyl methacrylate, ethoxyethyl methacrylate, butoxymethyl methacrylate, hydroxyethyl methacrylate and an oligomer thereof may be used, but is not limited thereto.

In the retardation film according to the present invention, the content of the acryl monomer in 1) the acryl copolymer is preferably in the range of 40 to 99% by weight, more preferably in the range of 50 to 98% by weight, and most preferably in the range of 60 to 97% by weight. In the case of when the content of the acryl monomer is less than 40% by weight, the high heat resistance and the high transparency which the acryl polymer intrinsically has may not be sufficiently shown, and in the case of when the content of the acryl monomer is more than 99% by weight, there is a problem in that the mechanical strength is reduced.

In the retardation film according to the present invention, as the aromatic vinyl monomer of 1) the acryl copolymer, there are styrene, α-methyl styrene, 4-methyl styrene and the like, and it is preferable to use styrene, but it is not limited thereto.

In the retardation film according to the present invention, the content of the aromatic vinyl monomer in 1) the acryl copolymer is preferably in the range of 1 to 60% by weight and more preferably in the range of more than 10% by weight and 60% by weight or less.

In the retardation film according to the present invention, in respects to the aromatic vinyl monomer such as styrenes, when it is stretched, the main chain of the styrenes is aligned in a stretching direction, and the benzene ring (substituent) having the relatively high electron density is aligned vertical to the stretching direction, thus realizing the lowest value of the alignment refractive index in the stretching direction. Thereby, the retardation film that has the (+) retardation value in the thickness direction.

In the case of when the content of the aromatic vinyl monomer in 1) the acryl copolymer is 10% by weight or less, since the retardation value that is developed according to the stretching ratio is low, the relatively high stretching may be required. Thus, in order to realize the high retardation value, it is more preferable that the content of the aromatic vinyl monomer is more than 10% by weight and 60% by weight or less.

In the retardation film according to the present invention, 1) the acryl copolymer may further comprise the maleic anhydride or maleimide monomer in the copolymer.

As the maleic anhydride or maleimide monomer, there are maleic anhydride, maleimide, N-methyl maleimide, N-ethyl maleimide, N-propyl maleimide, N-isopropyl maleimide and the like, but it is not limited thereto.

The content of the maleic anhydride or maleimide monomer in 1) the acryl copolymer is preferably in the range of 5 to 30% by weight and more preferably in the range of 5 to 10% by weight. In the case of when the content of the maleic anhydrate or maleimide monomer is more than 30% by weight, since the brittleness of the film is increased, there is a problem in that the film is easily broken.

In the case of the acryl copolymer that comprises the aromatic vinyl monomer, since the glass transition temperature of the resin is low, there is a problem in that when it is manufactured to form the film, heat resistance is poor. However, in the case of when the maleic anhydride or maleimide monomer is comprised in the acryl copolymer that comprises the aromatic vinyl monomer, there is an advantage in that the heat resistance of the acryl copolymer may be increased.

In the retardation film according to the present invention, 1) the acryl copolymer is preferably a copolymer of the acryl monomer and aromatic vinyl monomer, and more preferably the copolymer of the acryl monomer, the aromatic vinyl monomer, and the maleic anhydride monomer.

In the retardation film according to the present invention, the glass transition temperature (Tg) of 1) the acryl copolymer is in the range of 100 to 250° C., and more preferably in the range of 110 to 250° C. The retardation film that comprises the acryl copolymer in which the glass transition temperature (Tg) is in the range of 100 to 250° C. may have excellent durability.

In the retardation film according to the present invention, it is preferable that the refractive index of 1) the acryl copolymer is in the range of 1.480 to 1.550.

In the retardation film according to the present invention, in the case of 2) the rubber component, in the case of when the refractive index of the rubber component is similar to the refractive index of 1) the acryl copolymer, since the thermoplastic resin composition that has excellent transparency is capable of being obtained, it is not particularly limited as long as it is a rubber component that has the refractive index that is similar to that of 1) the acryl copolymer and is in the range of 1.480 to 1.550. To be more specific, 2) the rubber component is preferably an acryl rubber, a rubber-acryl graft type core-shell polymer having the refractive index in the range of 1.480 to 1.550, or a mixture thereof, but is not limited thereto.

Examples of the acryl rubber may include alkyl acrylates such as butyl acrylates and 2-ethyl hexyl acrylates, and examples of the rubber-acryl graft type core-shell polymer may include particles that include a rubber based on butadiene, butyl acrylate, or butyl acrylate-co-styrene copolymer as a core and poly(methyl methacrylate) (PMMA) or polystyrene as a shell and have the size in the range of 50 to 400 nm.

In the retardation film according to the present invention, the content of 2) the rubber component may be more than 0 and 20 parts by weight or less on the basis of 100 parts by weight of 1) the acryl copolymer. The content of 2) the rubber component is preferably in the range of 1 to 20 parts by weight, more preferably in the range of 1 to 15 parts by weight, and most preferably in the range of 1 to 10 parts by weight on the basis of 100 parts by weight of 1) the acryl copolymer. In the case of when the content of the rubber component is less than 1 part by weight, realization of the excellent mechanical strength of the retardation film is difficult to be ensured, a problem occurs in a processing process because the film is easily broken, and optical performance is not sufficiently realized. In addition, in the case of when the content is more than 20 parts by weight, the high heat resistance and the high transparency which the acryl copolymer intrinsically has may not be sufficiently shown and a problem such as the occurrence of haze in a stretching process may occur.

Meanwhile, in the case of when the rubber-acryl graft type core-shell polymer is included as 2) the rubber component, the content of the rubber-acryl graft type core-shell polymer is preferably more than 0 parts by weight and 10 parts by weight or less on the basis of 100 parts by weight of 1) the acryl copolymer, more preferably in the range of 0.5 to 7 parts by weight, and most preferably in the range of 1 to 5 parts by weight.

The retardation film according to the present invention may further comprise an additive such as a UV absorbing agent, a plasticizer, and a retardation accelerating agent.

The UV absorbing agent may be used alone or as a mixture thereof. Illustrative, but non-limiting examples of the UV absorbing agent may include a triazine UV absorbing agent, a triazole UV absorbing agent, a HALS (hindered amine light stabilizer) UV absorbing agent and the like. Examples of the triazine UV absorbing agent may include commercialized Tinuvin 360, Tinuvin 1577 (Ciba Chemicals), Cyasorb UV-1164, Cyasorb UV-2908, Cyasorb UV-3346 (Cytec) and the like, examples of the triazole UV absorbing agent may include Tinuvin 384, Tinuvin 1130, Cyasorb UV-2337, Cyasorb UV-5411 and the like, and examples of the HALS UV absorbing agent may include Cyasorb UV-3853.

Examples of the plasticizer include ester phosphates, ester carbonates, phthalates, and phosphates, and more specific examples thereof may include triphenyl phosphate, ester phthalates, dimethyl phthalates, diethyl phthalates, diphenyl phthalates and the like. In respects to the content of the plasticizer, it may be added while the properties of the retardation film are not reduced, and it is preferable that the appropriate content is 5 parts by weight or less on the basis of 100 parts by weight of 1) the acryl copolymer.

In order to control the retardation of the retardation film, a retardation accelerating agent may be added. As the retardation accelerating agent, a material that has an aromatic cycle is mainly used, and the number of aromatic cycles is not largely limited, but preferably in the range of 2 to 6. For example, trans-stilbene, diphenylacetylene, trans, trans-1,4-diphenyl-1,3-butadiene, biphenyl, fluorine, dibenzofuran, 2,7-dibromofluorene, carbazole, N-vinyl carbazole and the like may be used.

The content of the retardation accelerating agent may vary according to the desired retardation value, the amount of additives, and the stretching condition within the range in which optical properties of the retardation film are not reduced, but the amount of 10 parts by weight may be used on the basis of 100 parts by weight of 1) the acryl copolymer.

In the retardation film according to the present invention, it is preferable that the inplane retardation value that is represented by the above Equation 1 is in the range of 50 to 300 nm, and the thickness retardation value that is represented by the above Equation 2 is in the range of 50 to 300 nm.

The in-plane retardation value is preferably in the range of 50 to 300 nm and more preferably in the range of 70 to 200 nm. In the case of when the in-plane retardation value is less than 50 nm, optical properties that are required in the retardation film may not be ensured.

The thickness retardation value is preferably in the range of 50 to 300 nm and more preferably in the range of 70 to 200 nm. In the case of when the thickness retardation value is less than 50 nm, excellent optical properties that are the effect of the present invention may not be ensured.

In the retardation film according to the present invention, it is preferable that the MD tensile strength is 70 N/mm² or more, the TD tensile strength is 50 N/mm² or more, the thermal expansion coefficient is in the range of 30 to 100 ppm/K, and the haze is in the range of 0.1 to 1.0%.

The tensile strength is preferably 70 N/mm² or more in respects to MD, more preferably 75 N/mm² or more, and most preferably 80 N/mm² or more, and in respects to TD, it is preferably 50 N/mm², more preferably 55 N/mm² or more, and most preferably 60 N/mm² or more.

The thermal expansion coefficient is preferably in the range of 30 to 100 ppm/K, more preferably in the range of 30 to 90 ppm/K, and most preferably in the range of 30 to 80 ppm/K. In the case of when the thermal expansion coefficient is more than 100 ppm/K, the heat resistance and the durability may be reduced because of a change in dimension at high temperatures, thus causing deformation of the polarizing plate and the light leakage.

In addition, the method for manufacturing the retardation film according to the present invention comprises the steps of a) manufacturing an unstretched film by using an acryl copolymer that comprises an acryl monomer and an aromatic vinyl monomer and a rubber component; and b) stretching the unstretched film of step a).

In the method for manufacturing the retardation film according to the present invention, the acryl copolymer of step a) may further comprise a maleic anhydride or maleimide monomer in the copolymer, and since the detailed description of the acryl copolymer, rubber component and the like are the same as the above description, a description thereof will be omitted.

In the method for manufacturing the retardation film according to the present invention, the method for manufacturing the unstretched film of step a) may use a solution casting method or an extrusion molding method.

In the method for manufacturing the retardation film according to the present invention, the rubber component may be added to the solution in the solution casting, and in the case of when the extrusion molding method is used, it may be added to the acryl copolymer resin to be used.

The solution casting method is a method for manufacturing a film by using a solution (dope) in which the material is dissolved in an organic solvent.

Illustrative, but non-limiting examples of the organic solvent that is used in the solution casting method may include halogenated hydrocarbons such as methylene chloride, chloroform, and dichloroethane, ketones such as acetone, methyl ethyl ketone, diethyl ketone, and cyclohexanone, ethers such as di-isopropyl ether, tetrahydrofuran, 1,3-dioxane, and 1,4-dioxane, esters such as methyl acetate, and ethyl acetate, and amides such as dimethyl formamide, dimethyl acetamide and the like.

In the solution casting method, a dope may be manufactured by using a general method that is known in the art. By adding the solids such as the acryl copolymer resin and the additive in an amount in the range of 10 to 50% by weight on the basis of the organic solvent and agitating the solution, the dope may be manufactured. The manufacturing temperature is not largely limited, and may be controlled according to the property of the organic solvent. This solution may be manufactured under the pressure condition.

The order of addition of each component is not particularly limited, and it may be manufactured under the inert gas such as nitrogen gas. The manufactured dope is passed through a coat hanger type T-die, cast a chrome plating casting drum or belt, dried on a dry roll, and wound to manufacture the film.

As the method for manufacturing the unstretched film of step a), it may be manufactured by using the following melt casting method in addition to the solution casting method.

After the moisture and dissolved oxygen are removed by vacuum drying the acryl copolymer, the rubber component or additives are added thereto, they are supplied to a single or twin extruder that is substituted by nitrogen from a raw material hopper to an extruder thereof, and melted at high temperatures to obtain a raw material pellet, the obtained raw material pellet is vacuum dried, melted by using the single extruder that is substituted by nitrogen from a raw material hopper to an extruder thereof, passed through a coat hanger type T-die, and passed through a chrome plating casting roll and a dry roll to manufacture the film.

The unstretched film that is manufactured through the solution casting method or the extrusion molding method may obtain a desired retardation through the stretching treatment of step b). The stretching process may perform a machine direction (MD) stretching, a transverse direction (TD) stretching, or all of them. In the case of when it is stretched in the machine direction and the transverse direction, it may be stretched in another direction after it is stretched in one direction, or it may be stretched simultaneously in two directions. The stretching may be performed through one step, or through multisteps. In the case of when it is stretched in a machine direction, it may be stretched by a difference in a rate between the rolls, and in the case of when it is stretched in a transverse direction, a tenter is used. The rail initiation angle of the tenter is generally within 10°, thus a boeing phenomenon that occurs when it is stretched in a transverse direction is suppressed, and the angle of the optical axis is regularly controlled. By performing the stretching in a transverse direction through multisteps, a boeing suppression effect may be obtained.

In the method for manufacturing the retardation film according to the present invention, it is preferable that the stretching method of b) the unstretched film is performed by longitudinally uniaxially stretching it and the ratio of the width to the length of the stretched portion of the film is controlled.

b) the stretching step will be described in detail below.

The longitudinal and uniaxial stretching process according to the present invention may include a preheating step, a stretching step, and a heat treatment step, and the steps may be continuously performed. The longitudinal and uniaxial stretching process may be performed by using a device that is provided with a preheating zone, a stretching zone, and a heat treatment zone which are sequentially disposed.

The preheating step is referred to a step in which the film is preheated to be softened so that the unstretched film is desirably stretched during the stretching step after the preheating step.

In the preheating step, it is preferable that the unstretched film be heated at a temperature in the range of (Tg−30° C.) to Tg when a glass transition temperature of the unstretched film be Tg. It is preferable that the preheating time be in the range of 1 to 10 minutes to suppress unnecessary deformation, and more preferably, it is in the range of 1 to 5 min. If the film is desirably preheated during the preheating step, since the unstretched film is sufficiently softened, a declination of the retardation is small during the stretching. However, the preheating over a very long period of time undesirably increases the softening of the film. Thus, a high stretching ratio is required or it is difficult to obtain desirable birefringence.

During the stretching step that is performed after the preheating step, it is preferable that the unstretched film be stretched in a movement direction, that is, longitudinally and uniaxially stretched at a temperature in the range of (Tg−20° C.) to (Tg+20° C.). In this connection, the stretching temperature, the stretching rate, and the stretching ratio depend on the type and the thickness of the unstretched film and the required in-plane retardation of the optical film. During the longitudinal and uniaxial stretching method, it is more preferable that the stretching temperature be in the range of (Tg−10° C.) of the unstretched film to (Tg+10° C.). If the stretching temperature is less than (Tg−20° C.) of the unstretched film, stress is concentrated during the stretching. Thus, the retardation declination of the stretched film is increased. If the stretching temperature is more than (Tg+20° C.) of the unstretched film, it is difficult to obtain birefringence due to low molecular alignment.

In the method for manufacturing the retardation film according to the present invention, the stretching temperature in b) the stretching step varies according to the kind of the resin, but the temperature is preferably in the range of 80 to 250° C., more preferably in the range of 100 to 200° C., and most preferably in the range of 120 to 180° C.

In b) the stretching step, the stretching ratio depends on the thickness of the unstretched film and the retardation. However, it is preferable that the stretching ratio be 1.1 to 3. If the stretching ratio is lower than 1.1, it is difficult to form the film having the desirable retardation due to low birefringence. If the stretching ratio is higher than 3, a retardation declination of the stretched film is increased, causing an increase in neck-in.

In b) the stretching step, it is preferable that the stretching rate is in the range of 10 to 500%/minute.

In b) the stretching step, the ratio of the width to the length of the stretched portion of the film is preferably less than 3, more preferably 0.5 to 3, and most preferably 0.5 to 1.5.

In the present invention, by controlling the ratio of the width to the length of the stretched portion of the film, the ratio (Rₜₕ/Rₑ) of the thickness retardation value to the in-plane retardation value of the stretched film may be controlled, and the retardation deviation of the entire surface of the film may be reduced to 5 nm or less.

When the ratio of the width to the length of the stretched portion of the film is close to the range of 0.5 to 1.5, since the shrinkage in the width direction becomes free in the stretching step, the thickness retardation value becomes the same as the in-plane retardation value.

In addition, in the preheating step and the heat treating step that is performed after the stretching step, in order to fix the alignment of the longitudinally uniaxially stretched film, it is cooled such that the temperature of the film is in the range of (stretching temperature−50° C.) to (stretching temperature−10° C.) for the heat treatment.

If the retardation film according to the present invention is formed by using the device that is provided with the preheating zone, the stretching zone, and the heat treatment zone, the film that moves through the preheating zone, the stretching zone, and the heat treatment zone is continuously heated, stretched, and heat treated for cooling. However, intermediate temperature area may be formed at an interface between the zones. In order to prevent the intermediate temperature area from being formed, a narrow slit passage may be formed at the interface between the zones through which the film moves, but the present invention is not limited thereto. Furthermore, an adiabatic partition wall is provided at the interface to block heat, an air curtain is provided at the interface to block heat, or a combined process thereof is performed in order to maintain the temperatures of the zones.

As described above, in the retardation film that is manufactured according to the method of the present invention, it is preferable that the in-plane retardation value at 550 nm is in the range of 50 to 300 nm, and the thickness retardation value is in the range of 50 to 300 nm.

In addition, the present invention provides a liquid crystal display device that comprises one or more retardation films.

Since the retardation film according to the present invention is capable of having the in-plane retardation value in the range of 50 to 300 nm, and the thickness retardation value in the range of 50 to 300 nm, it is more preferable that it is applied to an IPS (In-Plane Switching) mode liquid crystal display device.

The liquid crystal display device that includes one or more retardation films will be described in detail below.

In a liquid crystal display device that includes a liquid crystal cell, and a first polarizing plate and a second polarizing plate that are provided on both sides of the liquid crystal cell respectively, the retardation film may be provided between the liquid crystal cell and the first polarizing plate and/or the second polarizing plate. That is, between the first polarizing plate and the liquid crystal cell, the retardation film may be provided, and between the second polarizing plate and the liquid crystal cell, or between the first polarizing plate and the liquid crystal cell and between the second polarizing plate and the liquid crystal cell, one or more retardation films may be provided.

The first polarizing plate and the second polarizing plate may comprise a protective film on one side or both sides thereof. Examples of the inner protective film may include a triacetate cellulose (TAC) film, a polynorbornene film that is made of a ring opening metathesis polymerization (ROMP), a HROMP (ring opening metathesis polymerization followed by hydrogenation) polymer film that is obtained by hydrogenating a ring opening cyclic olefin polymer, a polyester film, or a polynorbornene film that is manufactured by the addition polymerization. In addition to this, the film that is manufactured by using a transparent polymer material may be used as the protective film, but is not limited thereto.

In addition, the present invention provides an integrated polarizing plate which comprises a polarizing film; and the retardation film according to the subject invention on one side or both sides of the polarizing film as a protective film.

In the case of when the retardation film according to the present invention is provided on one side of the polarizing film, a protective film that is known in the art may be provided on another side thereof.

As the polarizing film, a film made of a polyvinyl alcohol (PVA) that comprises iodine or a dichromic dye may be used. The polarizing film may be manufactured by dyeing iodine or the dichromic dye on the PVA film, but the manufacturing method thereof is not particularly limited. In the present specification, the polarizing film means a state in which the protective film is not comprised, and the polarizing plate means a state in which the polarizing film and the protective film are comprised.

In the integrated polarizing plate of the present invention, the protective film and the polarizing film may be laminated with each other by using a method that is known in the art.

For example, the lamination of the protective film and the polarizing film may be performed by using an adhesion method using an adhesive. That is, first, on the surface of the PVA film that is the protective film or polarizing film of the polarizing film, the adhesive is coated by using a roll coater, a gravure coater, a bar coater, a knife coater, a capillary coater or the like. Before the adhesive is completely dried, the protective film and the polarizing film heated and pressed by using a lamination roll or pressed at normal temperature to be laminated. In the case of when a hot-melt type adhesive is used, the heat pressure roll is used.

Upon laminating the protection film with the polarizing plate, examples of the adhesive may include one-part or two-part polyvinyl alcohol (PVA) adhesive, polyurethane adhesive, epoxy adhesive, styrene butadiene rubber (SBR) adhesive, and hot melt adhesive, but are not limited thereto. When a polyurethane-based adhesive is used, it is preferably prepared from an aliphatic isocyanate-based compound which does not undergo yellowing by light. In the case where a one- or two-part adhesive for dry lamination or an adhesive with relatively low reactivity between isocyanate and hydroxy is used, it may be a solution adhesive in which an acetate solvent, a ketone solvent, an ether solvent, or an aromatic solvent is used as a diluent. Preferably, this adhesive has a low viscosity of 5000 cps or less. The adhesives are required to have excellent storage stability and a light transmission of 90% or higher at 400 to 800 nm.

If showing sufficient tackifying power, a tackifier may be used. If used, a tackifier is preferably heat- or UV-cured sufficiently to show resulting mechanical strength as high as that obtained with an adhesive. Also, the interface adhesion of the tackifier useful in the present invention is large enough so that delamination is possible only when one of the films bonded to each other therethrough is destroyed.

Examples of the tackifier useful in the present invention include tackifiers made from highly optically transparent natural rubber, synthetic rubber or elastomers, vinyl chloride/vinyl acetate copolymers, polyvinylalkyl ether, polyacrylate, or modified polyolefin, and curable tackifiers prepared by the addition of curing agents such as isocyanate to the above materials.

In addition, the present invention provides a liquid crystal display device that comprises the integrated polarizing plate.

In the case of when the liquid crystal display device according to the present invention comprises the above integrated polarizing plate, one or more retardation films according to the present invention may be comprised between the polarizing plate and the liquid crystal cell.

### MODE FOR THE INVENTION

Hereinafter, in order to help the understanding of the present invention, preferred Examples are provided. However, the following Examples are set forth to illustrate, but are not to be construed to limit the present invention.

### EXAMPLE

Measured values of the present invention were evaluated by the following analysis methods.

(Glass Transition Temperature)

The glass transition temperature was measured by increasing the temperature at a rate of 10° C./min to 250° C. using DSC (Differential scanning calorimeter, model DSC 8230) manufactured by Mettler Toledo, Co., Ltd.

(Retardation)

The retardation of the film was measured at an interval of 10° in the range of −50° to +50° in an extension direction and a direction that was vertical to this by using AxoScan (Axometrics). The in-plane retardation and the thickness retardation are defined by Rₑ (in-plane retardation) and Rₜₕ (thickness retardation) of Equations 1 and 2, respectively.

(Tensile Strength)

The tensile strength was measured at room temperature and a relative humidity of 50% by using UTM (Universal testing machine, model Z010) that was manufactured by Zwick/Roell, Co., Ltd. The sample was manufactured to have the width of 10 mm, and the tensile strength was measured at a tensile rate of 100 mm/min.

(Thermal Expansion Coefficient)

The thermal expansion coefficient was measured by using a TMA (Thermal mechanical analyzer, Mettler Toledo, Co., Ltd., TMA/SDATA840). The specimen was manufactured by performing cutting using a film cutter in a measurement direction into pieces having the width of 5 mm and the length of 15 mm, and the specimen was fixed to the film jig to measure the expansion length of the film according to the temperature in respects to 10 mm which was the length of the film. The load applied to the film was 0.02 N, the measurement temperature was in the range of 30 to 180° C., and the average expansion coefficient value in the range of 40 to 90° C. was recorded at a heating rate of 10° C./min.

(Transmittance)

The transmittance was measured using N&K Analyzer (model 1280, N&K Technology) by cutting the film into pieces having the width and the length of 40 mm. After it was measured from 200 nm to 900 nm, an average value in the range of 400 nm to 800 nm was recorded.

(Haze)

The haze was measured at a wavelength of 555 nm by using a hazemeter (model HR-100) that was manufactured by Murakami Color Research Laboratory, Co., Ltd.

### Example 1

In respects to 100 parts by weight of the acryl copolymer (Tg=129° C.) that included 75% by weight of methyl methacrylate, 11% by weight of maleic anhydride, and 14% by weight of styrene, 5 parts by weight of the butyl acrylate-methyl methacrylate resin graft type core-shell polymer was supplied from the raw material hopper to the extruder of 60 φ that was substituted by nitrogen and melted at 250° C. to obtain a raw material pellet, the obtained raw material pellet was vacuum dried, melted at 250° C. by using the extruder, passed through the coat hanger type of T-die, the chrome coated casting roll and the dry roll to manufacture the film having the thickness of 100 μm. The manufacture film was stretched at 110° C. in a longitudinal direction by 100% to obtain the retardation film having the thickness of 60 μm. The in-plane retardation value of the retardation film is 140 nm, the thickness retardation was 150 nm, the thermal expansion coefficient was 53 ppm/K, the haze was 0.6%, there was no brittleness, and the transparency was excellent. Those measured values and the other measured values are described in the following Table 1.

### Example 2

The film was manufactured under the same condition as Example 1, except that in respects to 100 parts by weight of the acryl copolymer (Tg=123° C.) that included 71% by weight of methyl methacrylate, 12% by weight of maleic anhydride, and 17% by weight of styrene, 7 parts by weight of the butyl acrylate-methyl methacrylate resin graft type core-shell polymer was dissolved in methylene chloride to manufacture a dope including 40% solids, and the film was manufactured by using the solution casting method and stretched at 120° C. in a longitudinal direction by 150%. The measured values are described in the following Table 1.

### Example 3

The retardation film was manufactured by using the same method as Example 1, except that in respects to 100 parts by weight of the acryl copolymer (Tg=122° C.) that included 72% by weight of methyl methacrylate, 13% by weight of maleic anhydride, and 15% by weight of styrene, 3 parts by weight of the butyl acrylate-methyl methacrylate resin graft type core-shell polymer was used. The measured values are described in the following Table 1.

### Example 4

The retardation film was manufactured by using the same method as Example 1, except that in respects to 100 parts by weight of the acryl copolymer (Tg=125° C.) that included 73% by weight of methyl methacrylate, 13% by weight of maleic anhydride, and 14% by weight of styrene, 5 parts by weight of the butadiene-methyl methacrylate resin graft type core-shell polymer was used. The measured values are described in the following Table 1.

### Example 5

The retardation film was manufactured by using the same method as Example 1, except that in respects to 100 parts by weight of the acryl copolymer (Tg=120° C.) that included 73% by weight of hydroxyethyl methacrylate, 13% by weight of maleic anhydride, and 14% by weight of styrene, 5 parts by weight of the butyl acrylate-methyl methacrylate resin graft type core-shell polymer was used. The measured values are described in the following Table 1.

### Comparative Example 1

The film was manufactured under the same condition as Example 1, except that in respects to 100 parts by weight of the acryl copolymer (Tg=122° C.) that included 78% by weight of methyl methacrylate, 10% by weight of maleic anhydride, and 12% by weight of styrene, 5 parts by weight of the rubber-acryl resin graft type core-shell polymer was not added, but in the roll, there were problems in the process in that wrinkles were formed on the film and the film was broken. The measured values are described in the following Table 1.

### Comparative Example 2

The film was manufactured under the same condition as Example 1, except that in respects to 100 parts by weight of the acryl copolymer (Tg=122° C.) that included 76% by weight of methyl methacrylate, 10% by weight of maleic anhydride, and 14% by weight of styrene, 20% by weight of the rubber-acryl resin graft type core-shell polymer was added. In the process, there were no defects, but optical performances were poor because the transmittance was 84.3% and the haze was 2.3%. The measured values are described in the following Table 1.

TABLE 1

| | | | | | | Comparative | Comparative |
|---|---|---|---|---|---|---|---|
| | Example 1 | Example 2 | Example 3 | Example 4 | Example 5 | Example 1 | Example 2 |
| acryl | MMA 75% | MMA 71% | MMA 72% | MMA 73% | HEMA 73% | MMA 78% | MMA 76% |
| copolymer | MA 11% | MA 12% | MA 13% | MA 13% | MA 13% | MA 10% | MA 10% |
| (% by weight) | ST 14% | ST 17% | ST 15% | ST 14% | ST 14% | ST 12% | ST 14% |
| T_{g}(° C.) | 129 | 123 | 122 | 125 | 121 | 129 | 131 |
| rubber | 5 | 7 | 3 | 5 | 5 | — | 20 |
| component | | | | | | | |
| (on the basis | | | | | | | |
| of 100 parts | | | | | | | |
| by weight of | | | | | | | |
| the acryl | | | | | | | |
| copolymer) | | | | | | | |
| Rₑ(nm) | 140 | 125 | 140 | 135 | 137 | 122 | 101 |
| Rₜₕ(nm) | 150 | 130 | 145 | 140 | 140 | 125 | 98 |
| MD tensile | 88 | 94 | 85 | 90 | 84 | 56 | 112 |
| strength | | | | | | | |
| (N/mm²) | | | | | | | |
| TD tensile | 69 | 88 | 73 | 72 | 70 | 49 | 96 |
| strength | | | | | | | |
| (N/mm²) | | | | | | | |
| thermal | 53 | 66 | 50 | 68 | 65 | 70 | 110 |
| expansion | | | | | | | |
| coefficient | | | | | | | |
| (ppm/K) | | | | | | | |
| penetration (%) | 91.5 | 90.2 | 91.9 | 91.3 | 91.2 | 92.3 | 84.3 |
| haze (%) | 0.6 | 0.7 | 0.5 | 0.6 | 0.6 | 0.3 | 2.3 |
| brittleness | low | low | low | low | low | high | low |

MMA: Methyl methacrylate,
HEMA: Hydroxyethyl methacrylate
MA: Maleic anhydride,
ST: Styrene.

From the results of Table 1, it can be seen that the retardation film according to the present invention has excellent heat resistance and optical transparency, and small haze, is not broken, and has excellent mechanical strength and durability.

1. A retardation film comprising:
1) an acryl copolymer that comprises an acryl monomer and an aromatic vinyl monomer; and
2) a rubber component,
wherein an in-plane retardation value that is represented by the following Equation 1 is in the range of 50 to 300 nm, and a thickness retardation value that is represented by the following Equation 2 is in the range of 50 to 300 nm:
Rₑ=(Nₓ−N_{y})×d [Equation 1]
Rₜₕ=(N_{z}−N_{y})×d [Equation 2]
wherein Nₓ is an in-plane refractive index in an extending direction of the film,
N_{y} is an in-plane refractive index in a direction that is vertical to the extending direction of the film,
N_{z} is a refractive index of the thickness direction of the film, and
d is the thickness of the film.

2. (canceled)

3. The retardation film according to claim 1, wherein the content of the acryl monomer in 1) the acryl copolymer is in the range of 40 to 99% by weight.

4. (canceled)

5. The retardation film according to claim 1, wherein the content of the aromatic vinyl monomer in 1) the acryl copolymer is in the range of 1 to 60% by weight.

6. The retardation film according to claim 1, wherein 1) the acryl copolymer further comprises a maleic anhydride or maleimide monomer in the copolymer.

7. The retardation film according to claim 6, wherein the maleic anhydride or maleimide monomer is selected from the group consisting of maleic anhydride, maleimide, N-methyl maleimide, N-ethyl maleimide, N-propyl maleimide and N-isopropyl maleimide.

8. The retardation film according to claim 6, wherein the content of the maleic anhydride or maleimide monomer in 1) the acryl copolymer is in the range of 5 to 30% by weight.

9. The retardation film according to claim 1, wherein the glass transition temperature (T_{g}) of 1) the acryl copolymer is in the range of 100 to 250° C.

10. The retardation film according to claim 1, wherein a refractive index of 1) the acryl copolymer is in the range of 1.480 to 1.550.

11. The retardation film according to claim 1, wherein a refractive index of 2) the rubber component is in the range of 1.480 to 1.550.

12. The retardation film according to claim 1, wherein 2) the rubber component is selected from the group consisting of an acryl rubber, a rubber-acryl graft type core-shell polymer, and a mixture thereof that has a refractive index in the range of 1.480 to 1.550.

13. The retardation film according to claim 12, wherein the content of the rubber-acryl graft type core-shell polymer is more than 0 parts by weight and 10 parts by weight or less on the basis of 100 parts by weight of 1) the acryl copolymer.

14. The retardation film according to claim 1, wherein 2) the rubber component is alkyl acrylate.

15. The retardation film according to claim 1, wherein 2) the rubber component is the rubber-acryl graft type core-shell polymer which is a particle comprising butadiene or butyl acrylate as a core and poly(methyl methacrylate) (PMMA) or polystyrene as a shell and having the size in the range of 50 to 400 nm.

16. The retardation film according to claim 1, wherein 2) the rubber component is the rubber-acryl graft type core-shell polymer which is a particle comprising a rubber based on butyl acrylate-co-styrene copolymer as a core, and poly(methyl methacrylate) (PMMA) or polystyrene as a shell and having the size in the range of 50 to 400 nm.

17. The retardation film according to claim 1, wherein the content of 2) the rubber component is more than 0 and 20 parts by weight or less on the basis of 100 parts by weight of 1) the acryl copolymer.

18. (canceled)

19. A method for manufacturing a retardation film, the method comprising the steps of:
a) manufacturing an unstretched film by using an acryl copolymer that comprises an acryl monomer and an aromatic vinyl monomer and a rubber component; and
b) stretching the unstretched film of step a),
wherein in-plane retardation value that is represented by the following Equation 1 is in the range of 50 to 300 nm, and thickness retardation value that is represented by the following Equation 2 is in the range of 50 to 300 nm:
Rₑ=(Nₓ−N_{y})×d [Equation 1]
Rₜₕ=(N_{z}−N_{y})×d [Equation 2]
wherein Nₓ is an in-plane refractive index in an extending direction of the film,
N_{y} is an in-plane refractive index in a direction that is vertical to the extending direction of the film,
N_{z} is a refractive index of the thickness direction of the film, and
d is the thickness of the film.

20. The method for manufacturing a retardation film according to claim 19, wherein the method for manufacturing the unstretched film in step a) is performed by using a solution casting method or an extrusion molding method.

21. A liquid crystal display device comprising one or more retardation films according to claim 1.

22. An integrated polarizing plate comprising a polarizing film; and the retardation film according to claim 1 on one side or both sides of the polarizing film as a protective film.

23. A liquid crystal display device comprising the integrated polarizing plate according to claim 22.
